(19) United States
(12) Patent Application Publication
(10) Pub. No.: US 2021/0127261 A1
(43) Pub. Date: Apr. 29, 2021

(54) HOUSEHOLD APPLIANCE COMMISSIONING

(71) Applicant: Haier US Appliance Solutions, Inc., Wilmington, DE (US)

(72) Inventor: Chad Michael Helms, Louisville, KY (US)

(21) Appl. No.: 16/663,909

(22) Filed: Oct. 25, 2019

(51) Int. Cl. H04W 12/00; H04L 12/28; H04L 29/06; H04W 88/08; H04W 88/12

(52) U.S. Cl. CPC H04W 12/00516; H04L 12/2803; H04L 29/06836; H04L 2012/2841; H04W 88/12; H04L 2012/285; H04W 88/085

(57) ABSTRACT

A method of commissioning a household appliance includes providing a soft access point having a known service set identifier format. The household appliance receives a signal from a user input and, in response, scans for the known service set identifier format and connects to the soft access point having the known service set identifier format. The household appliance also sends a device identifier and passphrase to a server via the soft access point. The server validates the device identifier and passphrase and then generates an account token. The server sends the account token to the appliance via the soft access point. The appliance connects to the server using the account token and the server then associates the appliance with the user account.

### FIELD OF THE INVENTION

The present subject matter relates generally to household appliances which can connect to a home network and/or a remote network such as the internet. In particular, the present subject matter relates to a household appliance configured for improved commissioning of the household appliance to a user account and related methods.

### BACKGROUND OF THE INVENTION

Household appliances are utilized generally for a variety of tasks by a variety of users. For example, a household may include such appliances as laundry appliances, e.g., a washer and/or dryer, kitchen appliances, e.g., a refrigerator, a microwave, and/or a coffee maker, along with room air conditioners and other various appliances.

Some household appliances can also include features for connecting to and communicating over a secure wireless network. Such communication may provide connected features on the household appliances, e.g., where the household appliance communicates with a personal device, smart home systems, and/or a remote database such as a cloud server.

Typically, such household appliances require multiple processes using multiple user interfaces in order to establish a connection or association, in particular an initial connection or association, between the household appliance and a user account.

Accordingly, there exists a need for an appliance which can be connected to a secured wireless network and added to a user account in an easier and more convenient manner.

### BRIEF DESCRIPTION OF THE INVENTION

Aspects and advantages of the invention will be set forth in part in the following description, or may be obvious from the description, or may be learned through practice of the invention.

In accordance with one embodiment of the present disclosure, a method of commissioning a household appliance is provided. The method includes receiving, on a remote user interface device, a request to add the appliance to a user account. The remote user interface device transmits the request to add the appliance to the user account to a server. The method also includes providing a soft access point having a known service set identifier format. The household appliance receives a signal from a user input and, in response to receiving the signal from the user input, scans for the known service set identifier format and connects to the soft access point having the known service set identifier format. The household appliance also sends a device identifier and passphrase to the server via the soft access point. The server validates the device identifier and passphrase and generates an account token after validating the device identifier and passphrase. The server then sends the account token to the appliance via the soft access point. The method further includes connecting the appliance to the server using the account token and associating the appliance with the user account.

In accordance with another embodiment of the present disclosure, a household appliance is provided. The household appliance includes a cabinet. A user input is positioned on an exterior of the cabinet. The household appliance also includes a controller configured to receive a signal from the user input and scan for a known service set identifier format in response to receiving the signal from the user input. The controller is also configured to connect to a soft access point having the known service set identifier format. The controller is further configured to send, via the soft access point, a device identifier and passphrase, to receive, via the soft access point, an account token, and to connect to a server using the account token.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of exemplary laundry appliances in accordance with one or more example embodiments of the present disclosure.

FIG. 2 provides a front view of an exemplary group of kitchen appliances in accordance with additional example embodiments of the present disclosure.

FIG. 3 provides a schematic view of a new appliance communicating with a remote server via an existing appliance in accordance with one or more example embodiments of the present disclosure.

FIG. 4 provides a schematic view of the new appliance of FIG. 3 communicating with the remote server without having to go through the existing appliance.

FIGS. 5 and 6 provides a flowchart illustrating an example method of commissioning a household appliance according to one or more example embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

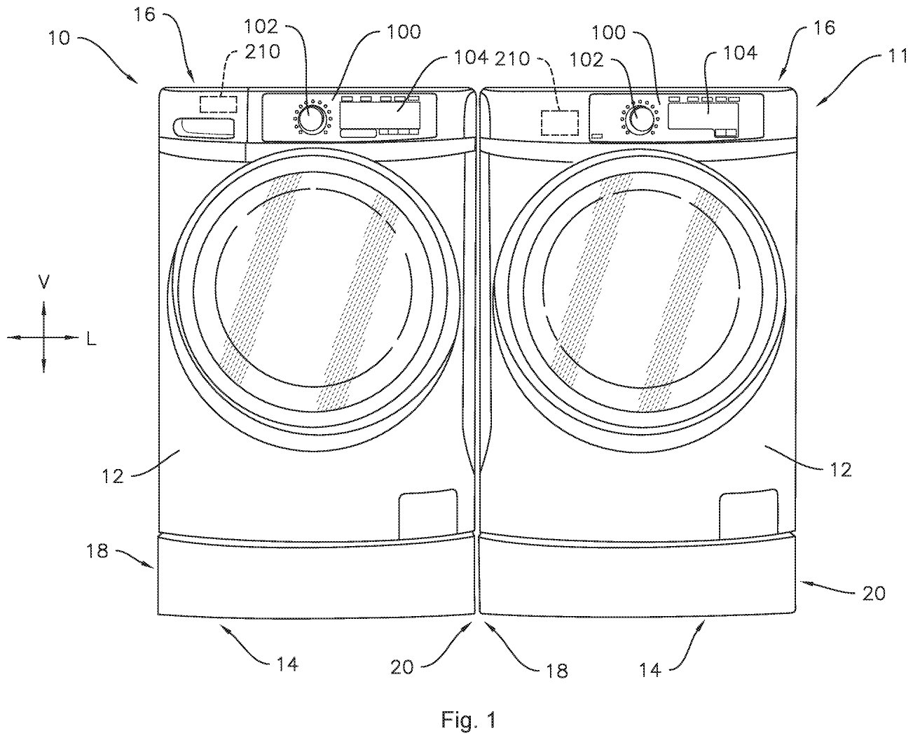

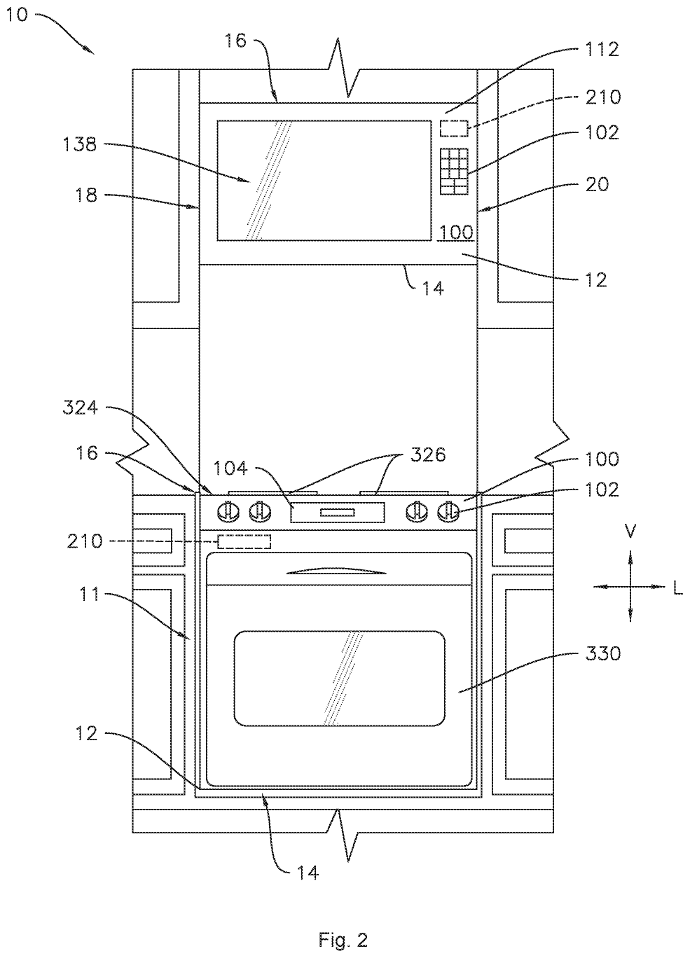

As may be seen in FIGS. 1 and 2, in accordance with one or more embodiments of the present subject matter, a group of appliances including at least a first appliance 10 and a second appliance 11 is provided. The illustrated group of two appliances is provided by way of example only. Various embodiments of the present subject matter may also include three or more appliances, wherein one appliance of the group of three of more appliances transmits and receives wireless signals and relays signals to the remaining two or more appliances of the group for commissioning the remaining two or more appliances.

As generally seen throughout FIGS. 1 and 2, each appliance 10 and 11 includes a cabinet 12 which defines a vertical direction V, a lateral direction L and a transverse direction T that are mutually perpendicular. Each cabinet 12 extends between a top side 16 and a bottom side 14 along the vertical direction V. Each cabinet 12 also extends between a left side 18 and a right side 20, e.g., along the lateral direction L, and a front side 22 and a rear side 24, e.g., along the transverse direction T.

Each appliance 10 and 11 may include a user interface panel 100 and a user input device 102 which may be positioned on an exterior of the cabinet 12. The user input device 102 is generally positioned proximate to the user interface panel 100, and in some embodiments, the user input device 102 may be positioned on the user interface panel 100.

In various embodiments, the user interface panel 100 may represent a general purpose I/O (“GPIO”) device or functional block. In some embodiments, the user interface panel 100 may include or be in operative communication with user input device 102, such as one or more of a variety of digital, analog, electrical, mechanical or electro-mechanical input devices including rotary dials, control knobs, push buttons, and touch pads. The user interface panel 100 may include a display component 104, such as a digital or analog display device designed to provide operational feedback to a user. The display component 104 may also be a touchscreen capable of receiving a user input, such that the display component 104 may also be a user input device in addition to or instead of the user input device 102.

Generally, each appliance 10 and 11 may include a controller 210 in operative communication with the user input device 102. The user interface panel 100 and the user input device 102 may be in communication with the controller 210 via, for example, one or more signal lines or shared communication busses. Input/output (“I/O”) signals may be routed between controller 210 and various operational components of the appliances 10 and 11. Operation of the appliances 10 and 11 may each be regulated by the respective controller 210 that is operatively coupled to the corresponding user interface panel 100. A user interface panel 100 may for example provide selections for user manipulation of the operation of an appliance, e.g., via user input device 102 and/or display 104. In response to user manipulation of the user interface panel 100 and/or user input device 102, the controller 210 may operate various components of the appliance 10 or 11. Each controller 210 may include a memory and one or more microprocessors, CPUs or the like, such as general or special purpose microprocessors operable to execute programming instructions or micro-control code associated with operation of the appliance 10 or 11. The memory may represent random access memory such as DRAM, or read only memory such as ROM or FLASH. In one embodiment, the processor executes programming instructions stored in memory. The memory may be a separate component from the processor or may be included onboard within the processor. Alternatively, a controller 210 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

The controller 210 may be programmed to operate the respective appliance 10 or 11 by executing instructions stored in memory. For example, the instructions may be software or any set of instructions that when executed by the processing device, cause the processing device to perform operations. Controller 210 can include one or more processor(s) and associated memory device(s) configured to perform a variety of computer-implemented functions and/or instructions (e.g. performing the methods, steps, calculations and the like and storing relevant data as disclosed herein). It should be noted that controllers 210 as disclosed herein are capable of and may be operable to perform any methods and associated method steps as disclosed herein.

In some embodiments, for example, as illustrated in FIG. 1, the group of appliances 10 and 11 may be a pair of laundry appliances. In the exemplary embodiment illustrated in FIG. 1, the first appliance may be a washing machine appliance 10 and the second appliance may be a clothes dryer 11. In other embodiments, the washing machine appliance may be the second appliance and the clothes dryer may be the first appliance. In embodiments such as illustrated in FIG. 1, the user input device 102 of each appliance 10 and 11 may be positioned on the user interface panel 100. The embodiment illustrated in FIG. 1 also includes a display 104 on the user interface panel.

FIG. 2 illustrates another example embodiment of a group of appliance where the first appliance 10 and the second appliance 11 are kitchen appliances. In this example, the first appliance 10 is a microwave oven that is generally positioned above a cooktop appliance 11, e.g., along the vertical direction V.

Microwave oven appliance 10 includes a cabinet 12. A cooking chamber is defined within the cabinet 12 of the microwave 10. The cooking chamber is accessible via a door 112 and viewable through a window 138 in the door 112. Microwave 10 is configured to heat articles, e.g., food or beverages, within the cooking chamber using electromagnetic radiation. Microwave appliance 10 may include various components which operate to produce the electromagnetic radiation, as is generally understood. For example, microwave appliance 10 may include a magnetron (such as, for example, a cavity magnetron), a high voltage transformer, a high voltage capacitor and a high voltage diode. The transformer may provide energy from a suitable energy source (such as an electrical outlet) to the magnetron. The magnetron may convert the energy to electromagnetic radiation, specifically microwave radiation. The capacitor generally connects the magnetron and transformer, such as via high voltage diode, to a chassis. Microwave radiation produced by the magnetron may be transmitted through a waveguide to the cooking chamber. The structure and intended function of microwave ovens are generally understood by those of ordinary skill in the art and are not described in further detail herein.

As shown, cooktop appliance 11 includes a chassis or cabinet 12 that extends along the vertical direction V between a top side 16 and a bottom side 14. Cooktop appliance 11 can include a cooktop surface 324 having one or more heating elements 326 for use in, for example, heating or cooking operations. In one example embodiment, cooktop surface 324 is constructed with ceramic glass. In other embodiments, however, cooktop surface 324 may include any another suitable material, such as a metallic material (e.g., steel) or another suitable non-metallic material. Heating elements 326 may be various sizes and may employ any suitable method for heating or cooking an object, such as a cooking utensil (not shown), and its contents. In one embodiment, for example, heating element 326 uses a heat transfer method, such as electric coils or gas burners, to heat the cooking utensil. In another embodiment, however, heating element 326 uses an induction heating method to heat the cooking utensil directly. In various embodiments, the heating elements 326 may include one or more of a gas burner element, resistive heat element, radiant heat element, induction element, or another suitable heating element.

In some embodiments, the cabinet 12 of the cooktop appliance 11 may be insulated and may define a cooking chamber selectively enclosed by a door 330. One or more heating elements (e.g., top broiling elements or bottom baking elements) may be positioned within cabinet 12 of cooktop appliance 11 to heat cooking chamber. Heating elements within cooking chamber may be provided as any suitable element for cooking the contents of cooking chamber, such as an electric resistive heating element, a gas burner, a microwave element, a halogen element, etc. Thus, cooktop appliance 11 may be referred to as an oven range appliance. As will be understood by those skilled in the art, cooktop appliance 11 is provided by way of example only, and the present subject matter may be used in the context of any suitable cooking appliance, such as a double oven range appliance or a standalone cooktop (e.g., fitted integrally with a surface of a kitchen counter). Thus, the example embodiments illustrated and described are not intended to limit the present subject matter to any particular cooking chamber or heating element configuration, unless explicitly indicated as being limited.

As illustrated, a user interface panel 100 may be provided on cooktop appliance 11. Although shown at front portion of cooktop appliance 11, another suitable location or structure (e.g., a backsplash) for supporting user interface panel 100 may be provided in alternative embodiments. In some embodiments, user interface panel 100 includes input components or controls 102, such as one or more of a variety of electrical, mechanical, or electro-mechanical input devices. Controls 102 may include, for example, rotary dials, knobs, push buttons, and touch pads. A controller 210 is in communication with user interface panel 100 and controls 102 through which a user may select various operational features and modes and monitor progress of cooktop appliance 11. In additional or alternative embodiments, user interface panel 100 includes a display component, such as a digital or analog display in communication with a controller 210 and configured to provide operational feedback to a user. In certain embodiments, user interface panel 100 represents a general purpose I/O (“GPIO”) device or functional block.

As shown, controller 210 is communicatively coupled (i.e., in operative communication) with user interface panel 100 and its controls 102. Controller 210 may also be communicatively coupled with various operational components of cooktop appliance 300 as well, such as heating elements (e.g., 326, 332), sensors, and the like. Input/output (“I/O”) signals may be routed between controller 210 and the various operational components of cooktop appliance 11. Thus, controller 210 can selectively activate and operate these various components. Various components of cooktop appliance 11 are communicatively coupled with controller 210 via one or more communication lines such as, for example, conductive signal lines, shared communication busses, or wireless communications bands.

According to various embodiments of the present disclosure, the appliances 10 and 11 may take the form of any of the examples described above, or may be any other household appliance where improved ease of commissioning the appliance is desired. Thus, it will be understood that the present subject matter is not limited to any particular household appliance. Further, the group of appliances need not necessarily be related or located in the same room as one another. For instance, while the first and second appliances 10 and 11 are both laundry appliances in the example illustrated in FIG. 1 and are both kitchen appliances in the example illustrated in FIG. 2, the group of appliances can include any two or more appliances which are within communication range, e.g., within WI-FI® range, of each other. Thus, in just one possible example, the first appliance 10 could be a refrigerator appliance, and the second appliance 11 could be any of the other example appliances described herein, such as the washer and/or dryer of FIG. 1, as well as any other household appliance.

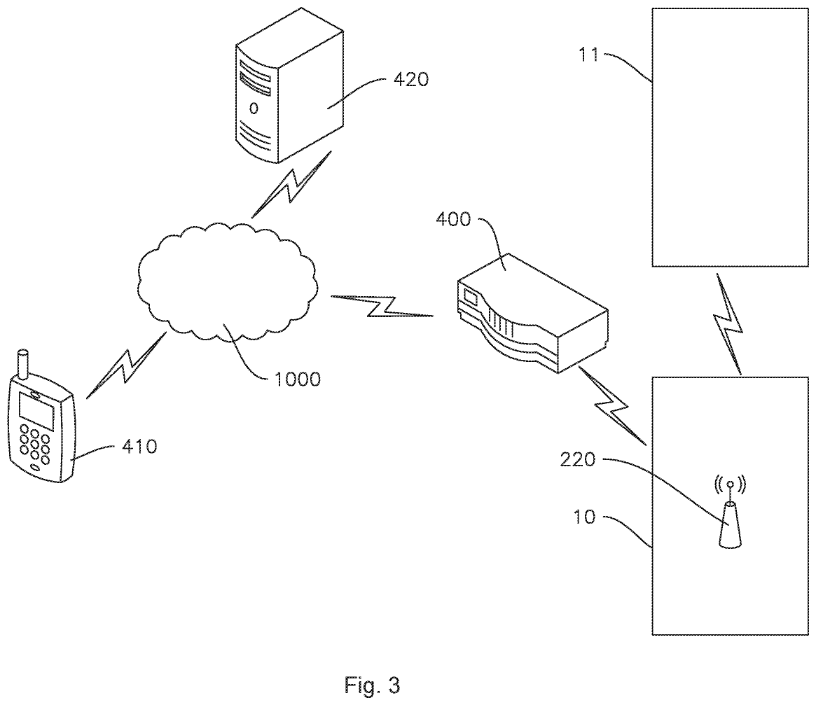

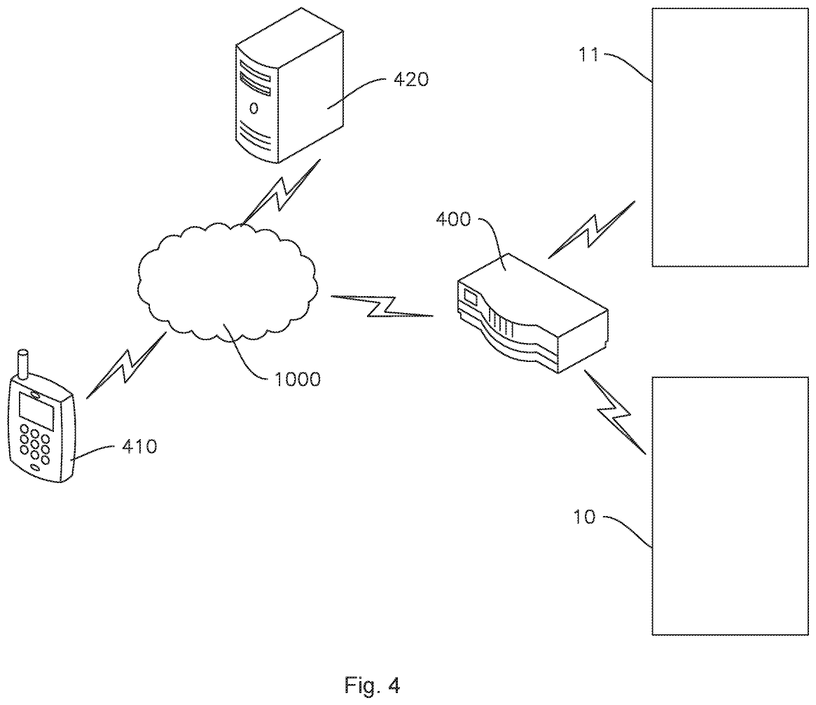

Turning now generally to FIGS. 3 and 4, the appliances 10 and 11, and in particular, controllers 210 thereof, may be configured to communicate with each other and/or with a separate, external, device, such as a communications device or other remote user interface device 410 and/or a remote server 420, either directly or via a network such as the internet 1000. The appliances 10 and 11 may access the internet 1000 via an access point such as a modem or router 400, which may be a part of a WI-FI® network, e.g., in a user's home. The remote user interface device 410 may be a laptop computer, smartphone, tablet, personal computer, wearable device, smart home system, and/or various other suitable devices including a user interface such as a touchscreen display. The remote user interface device 410 may include a memory for storing and retrieving programming instructions. For example, the remote user interface device 410 may be a smartphone operable to store and run applications, also known as “apps,” and may include a remote user interface provided as a smartphone app. The appliances 10 and/or 11 may be in communication with each other and the separate external device 410 and/or 420 through various possible communication connections and interfaces, such as but not limited to Zigbee, BLUETOOTH®, WI-FI®, or any other suitable communication connection.

Methods and systems according to the present disclosure advantageously provide a smoother and more convenient user experience when commissioning one or more new appliances 11. For example, commissioning the appliance or appliances may include connecting the appliance(s) to a WI-FED network for the first time and/or adding the appliance or appliances to a user account on the remote server 420.

FIG. 3 provides a schematic view of the second appliance 11 communicating with the internet 1000 via the first appliance 10. Thus, the second appliance 11 may be a new appliance 11 and the first appliance 10 may be an existing or already-commissioned appliance 10. As shown, in FIG. 3, the new appliance 11 may communicate with additional devices, e.g., remote user interface device 410 and/or remote server 420 via a soft access point (soft AP) 220 provided on the first appliance 10. In other embodiments, the soft AP 220 may also or instead be provided on the remote user interface device 410. Also, it should be understood that two appliances 10 and 11 are illustrated by way of example only, in at least some embodiments, more than one new appliance, e.g., two new appliances, or three new appliances, or more, may be commissioned at the same time.

In some embodiments, commissioning of the new appliance 11 may be initiated by requesting to add the new appliance 11 to a user account and by manipulating a user input 102, e.g., pressing a button, on the new appliance 11. For example, a method of commissioning the new appliance 11 may include receiving a request to add the appliance 11 to a user account on the remote user interface device 410. For example, the remote user interface device 410 may be a smartphone running an appliances app and a user may initiate the request to add the appliance 11 to the user's account via the smartphone app, such as by pressing a button or touchscreen on the smartphone 410. The request to add the appliance 11 to the user account may be transmitted from the remote user interface device 410 to the server 420 via the network 1000, e.g., the internet or a cellular data network, etc. When the server 420 receives the request to add the new appliance 11, the server 420 may then send a command to enable soft AP 220 to one or both of the remote user interface device 410 and/or the existing, previously commissioned appliance 10. For example, the server 420 may check for existing appliances on the user's account and send the command to the existing appliance(s) when such are detected, or may send the command to the remote user interface device 410, e.g., when an existing appliance on the user's account is not detected.

The soft AP 220 may have a known service set identifier (SSID) format. The known SSID format may permit the new appliance 10 to recognize the soft AP 220. For example, the known SSID format may be preprogrammed into a memory of the controller 210.

The example method of commissioning the new appliance 11 may further include receiving a signal from a user input 102 on the household appliance 11, such as a signal generated in response to the user pressing a button or touchscreen or, as another example input, issuing a verbal command to a voice-enabled appliance. The new appliance 11 may then scan for the known SSID format of the soft AP 220 in response to receiving the signal from the user input 102. The new appliance 11 may then recognize the known SSID format and connect to the soft AP 220.

For example, the new appliance 11 may establish a secure connection, such as a transport layer security (TLS) connection, to the soft AP 220, e.g., on the existing appliance 10. The new appliance 11 may then receive and verify a certificate of the device providing the soft AP 220, e.g., the existing appliance 10 and/or remote user interface device 410, over the secure connection. Additionally, the device providing the soft AP 220 may also receive and verify a certificate from the new appliance 11.

Once connected to the soft AP 220, the new appliance 11 may send a device identifier (device ID) and passphrase from the appliance 11 to the server 420 via the soft access point 220. In at least some embodiments, the device ID and passphrase may be sent only after establishing a secure connection and verifying the certificate of the device providing the soft AP 220, e.g., the existing appliance 10. The server 420 then validates the device ID and the passphrase, and generates an account token after validating the device ID and passphrase.

The account token may be sent from the remote server 420 to the appliance 11 via the soft AP 220. For example, the server 420 may send the account token to the device providing the soft AP 220, e.g., the remote user interface device 410 and/or the existing appliance 10. The device providing the soft AP 220 may then relay the account token along with a network credential, e.g., a password for the user's home router 400, to the new appliance 11. In some embodiments, the account token may also be sent to the remote user interface device 410, such as to add the new appliance 11 to the appliances app running on the remote user interface device 410.

After receiving the network credential, the new appliance 11 may disconnect from the soft AP 220 and connect directly to the network, e.g., may connect directly to the user's home WI-FI® network via the router 400, as illustrated for example in FIG. 4. Once connected directly to the router 400, the new appliance 11 may then connect to the remote server 420 via the router 400 and may connect using the account token. The server 420 may then associate the new appliance 11 with the user account. The server 420 may also, in some embodiments, send a command to disable the soft AP 220 to the device providing the soft AP 220, e.g., the existing appliance 10 and/or the remote user interface device 410, after the appliance 11 connects to the server 420 using the account token.

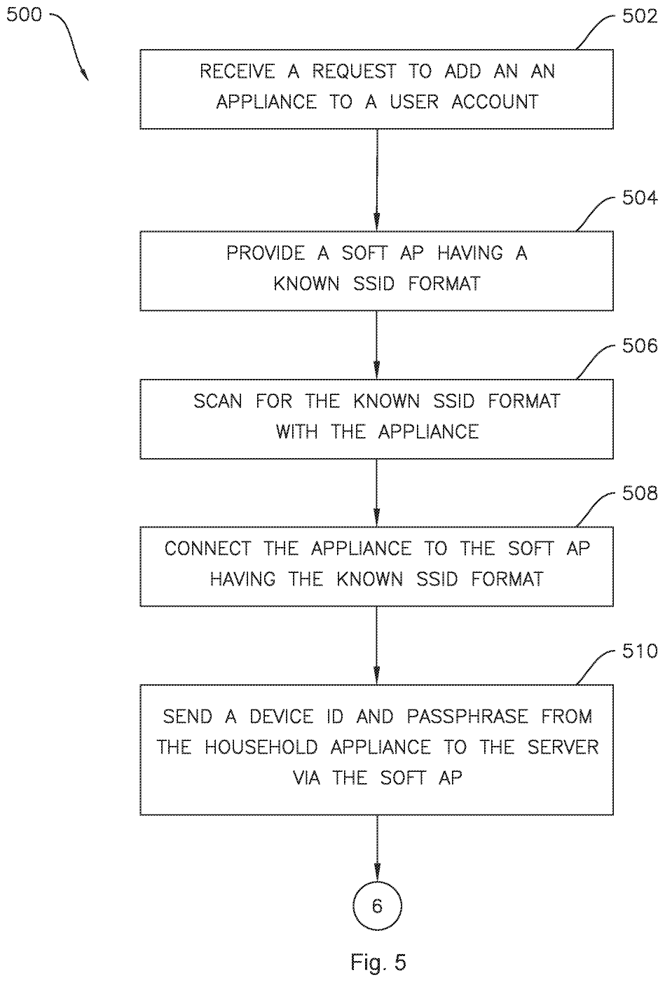

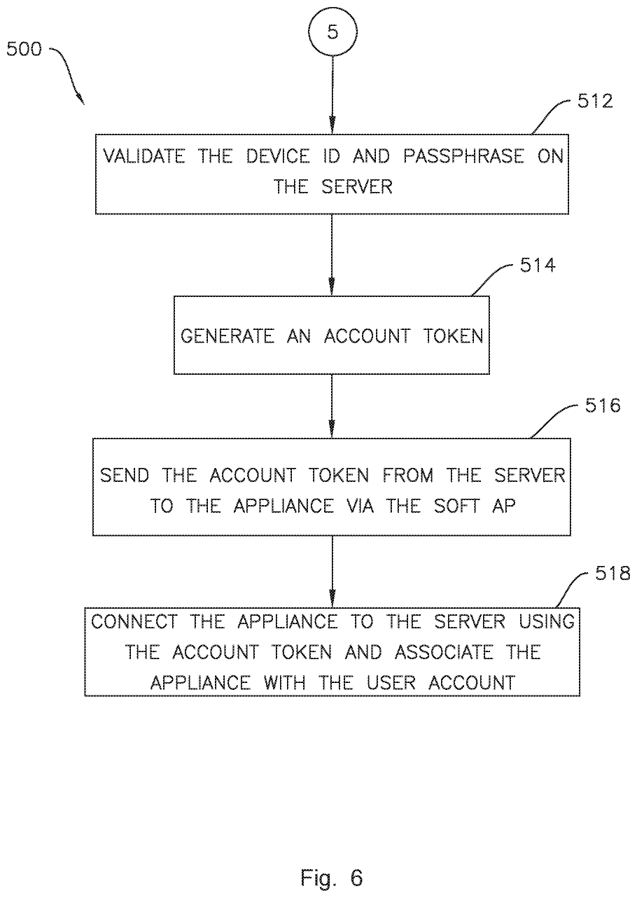

Exemplary methods according to the present subject matter include the method 500 illustrated in FIGS. 5 and 6. As illustrated in FIG. 5, in some embodiments, an example method 500 of commissioning a household appliance, such as the example household appliance 11, may include a step 502 of receiving a request to add the appliance to a user account, e.g., on a remote user interface device, such as the remote user interface device 410. The method may then include transmitting the request to add the appliance to the user account to a server, e.g., from the remote user interface device. The method 500 may also include a step 504 of providing a soft AP having a known SSID format, for example the soft AP having the known SSID format may be provided in response to the request to add the appliance to the user account.

The method 500 may also include receiving, on the household appliance, a signal from a user input and a step 506 of scanning for the known SSID format with the appliance. For example the step 506 may be performed in response to the user input and/or a signal generated by the user input, such as the user input 102 described hereinabove in various example embodiments.

The method 500 may further include a step 508 of connecting the household appliance to the soft access point having the known service set identifier format. Once the household appliance is connected, the method 500 may include a step 510 of sending a device identifier and passphrase from the household appliance to the server via the soft access point.

Turning now to FIG. 6, method 500 may continue with a step 512 of validating the device identifier and passphrase on the server. Also as illustrated in the example embodiment of FIG. 6, the method 500 may further include a step 514 of generating an account token, e.g., by the server after validating the device identifier and passphrase.

In some embodiments, method 500 may also include a step 516 of sending the account token from the server to the appliance via the soft access point. The soft access point may relay the account token to the appliance and may also, in some embodiments, send a network credential to the appliance with the account token. Method 500 may also include a step 518 of connecting the appliance to the server using the account token and associating the appliance with the user account.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of commissioning a household appliance, the method comprising:
receiving, on a remote user interface device, a request to add the appliance to a user account;
transmitting the request to add the appliance to the user account from the remote user interface device to a server;
providing a soft access point having a known service set identifier format;
receiving, on the household appliance, a signal from a user input;
scanning, with the household appliance, for the known service set identifier format in response to receiving the signal from the user input;
connecting the household appliance to the soft access point having the known service set identifier format;
sending a device identifier and passphrase from the household appliance to the server via the soft access point;
validating the device identifier and passphrase on the server;
generating an account token by the server after validating the device identifier and passphrase;
sending the account token from the server to the appliance via the soft access point; and
connecting the appliance to the server using the account token and associating the appliance with the user account.

2. The method of claim 1, further comprising sending a command to enable soft access point from the server to at least one existing appliance on the user account, wherein the step of providing the soft access point comprises providing the soft access point with the known service set identifier format on the existing appliance.

3. The method of claim 1, further comprising sending a command to enable soft access point from the server to the remote user interface device, wherein the step of providing the soft access point comprises providing the soft access point with the known service set identifier format on the remote user interface device.

4. The method of claim 1, wherein connecting the household appliance to the soft access point having the known service set identifier format comprises establishing a TLS connection.

5. The method of claim 4, further comprising sending and receiving device certificates via the TLS connection and verifying the device certificates before sending the device identifier and passphrase.

6. The method of claim 1, further comprising sending the account token from the server to the remote user interface device.

7. The method of claim 1, wherein the step of sending the account token from the server to the appliance via the soft access point comprises sending the account token from the server to the soft access point and sending the account token and a network credential to the appliance from the soft access point.

8. The method of claim 7, further comprising disconnecting from the soft access point after receiving the network credential and connecting to a network using the network credential.

9. The method of claim 7, further comprising sending a command to enable soft access point from the server to at least one existing appliance on the user account, wherein the step of providing the soft access point comprises providing the soft access point having the known service set identifier format on the existing appliance, and further comprising sending a command to disable soft access point from the server to the at least one existing appliance on the user account after connecting the appliance to the server using the account token.

10. The method of claim 7, further comprising sending a command to enable soft access point from the server to the remote user interface device, wherein the step of providing the soft access point comprises providing the soft access point having the known service set identifier format on the remote user interface device, and further comprising sending a command to disable soft access point from the server to the remote user interface device after connecting the appliance to the server using the account token.

11. The method of claim 1, wherein the household appliance is one of a plurality of household appliances, and each household appliance of the plurality of household appliances is commissioned at the same time as every other household appliance of the plurality of household appliances.

12. A household appliance comprising:
a cabinet;
a user input positioned on an exterior of the cabinet; and
a controller configured to:
receive a signal from the user input;
scan for a known service set identifier format in response to receiving the signal from the user input;
connect to a soft access point having the known service set identifier format;
send, via the soft access point, a device identifier and passphrase;
receive, via the soft access point, an account token; and
connect to a server using the account token.

13. The household appliance of claim 12, wherein the controller is further configured to receive a network credential via the soft access point.

14. The household appliance of claim 13, wherein the controller is further configured to disconnect from the soft access point after receiving the network credential and to connect to a network using the network credential.

15. The household appliance of claim 12, wherein the soft access point is provided on a second household appliance.

16. The household appliance of claim 12, wherein the soft access point is provided on remote user interface device

17. The household appliance of claim 12, wherein the controller is configured to connect to the soft access point using a TLS connection.

18. The household appliance of claim 17, wherein the controller is further configured to verify a device certificate from the soft access point prior to sending the device identifier and passphrase.
